(19) United States
(12) Patent Application Publication
(10) Pub. No.: US 2020/0009952 A1
(43) Pub. Date: Jan. 9, 2020

(54) SUNROOF APPARATUS

(71) Applicant: AISIN WUXI BODY PARTS CO., LTD., Jiangsu (CN)

(72) Inventor: Kazuki SAWADA, Jiangsu (CN)

(73) Assignee: AISIN WUXI BODY PARTS CO., LTD., Jiangsu (CN)

(21) Appl. No.: 16/263,367

(22) Filed: Jan. 31, 2019

(30) Foreign Application Priority Data
Jul. 9, 2018 (CN) 201821086137.3

(51) Int. Cl. B60J 7/043; B60J 7/00; B60J 7/02

(52) U.S. Cl. CPC B60J 7/043; B60J 7/022; B60J 7/0015

(57) ABSTRACT

A sunroof apparatus includes: a roof opening, a bent portion formed by bending a vehicle top plate downward is arranged on an edge of the roof opening; a movable panel which is configured to move along a vehicle front-rear direction to open and close the roof opening; a sealing member which is arranged on a front end edge and a rear end edge of the movable panel along a vehicle widthwise direction and on a left end edge and a right end edge of the movable panel and is provided with a main body portion and a press-contacted portion that is connected with the main body portion and that is pressed and contacted with a lower end of the bent portion in a vehicle upper-lower direction in a fully closed state; and a panel reinforcement portion which supports the movable panel and is arranged below the sealing member.

### TECHNICAL FIELD

The invention relates to a sunroof apparatus, and more particularly, to a sunroof apparatus for a vehicle.

### BACKGROUND

In the prior art, there is a known sunroof apparatus in which a pair of guide rails is arranged at two opposite edges in a vehicle widthwise direction of a substantially quadrangular opening formed at a roof of a vehicle, and a movable panel of the sunroof apparatus is supported to open and close the opening through movement of a functional member along the pair of guide rails.

For example, the functional member is a shoe for supporting the movable panel so as to move along a front-rear direction, a bracket for supporting the movable panel so as to move obliquely, etc.

A sealing member abutting against a roof opening are arranged on front, rear, left and right edges of the movable panel to prevent water, dust or the like from entering into a vehicle, and in a vehicle manufacturing factory, the height of the movable panel with respect to a vehicle top plate is adjusted so that they are located on the same plane.

In addition, the patent document 1 discloses a sunroof apparatus. Specifically, referring to FIG. 5 of the present application that schematically shows FIG. 2b of the patent document 1, a sealing member 102 abutting against a panel 101 is arranged on an open end edge of a roof main body 100.

### PRIOR ART DOCUMENT

Patent document 1: US invention patent U.S. Pat. No. 8,177,294

However, the sunroof apparatus of the patent document 1 has a problem that the roof and the panel are in contact at the front, rear, left and right through the sealing member. Therefore, when the vehicle is traveling at a high speed, the rigidity of a functional member or the panel needs to be reinforced to prevent the panel from being sucked out.

In addition, there is a problem that a position of a surface of the movable panel with respect to the vehicle top plate needs to be adjusted in the vehicle manufacturing factory.

### SUMMARY

The object of the invention is to provide a sunroof apparatus capable of effectively preventing a movable panel from being sucked out upward by means of the movable panel and a functional member with relatively low rigidity, thereby realizing a light-weight and low-cost structure, and moreover, the procedure of adjusting a position of a surface of the movable panel with respect to the vehicle top plate in the vehicle manufacturing factory is not needed.

A technical solution of the invention is as follows: a sunroof apparatus includes: a roof opening, a bent portion formed by bending a vehicle top plate downward is arranged on an edge of the roof opening; a movable panel which is configured to move along a vehicle front-rear direction to open and close the roof opening and is located below a roof when the sunroof apparatus is in a fully open state; a sealing member which is arranged on a front end edge and a rear end edge of the movable panel along a vehicle widthwise direction and on a left end edge and a right end edge of the movable panel along the vehicle front-rear direction, the sealing member being provided with a main body portion and a press-contacted portion connected with the main body portion, the press-contacted portion being pressed and contacted with a lower end of the bent portion in a vehicle upper-lower direction in a fully closed state of the sunroof apparatus; and a panel reinforcement portion which supports the movable panel and is arranged below the sealing member.

According to the technical solution, as the sealing member has a structure capable of being pressed and contacted with the lower end of the bent portion of the vehicle top plate in the vehicle upper-lower direction, the movable panel is prevented from being sucked out upward by such an upper-lower press-contacted structure, and therefore the requirement on the rigidity of the movable panel and the functional member can be reduced, and thus the light-weight and low-cost structure can be achieved.

In the above technical solution, preferably, the press-contacted portion of the sealing member has a first hollow portion.

Therefore, the sealing member can be formed with a simple structure.

In the above technical solution, preferably, filling members are arranged in the first hollow portion of the sealing member which is arranged on the front end edge and the rear end edge of the movable panel, and the filling members are located at centers in the vehicle widthwise direction in the first hollow portion.

As a functional member for supporting the panel reinforcement portion and the sealing members is not arranged on the front end edge and the rear end edge of the movable panel, by filing the filling members in the first hollow portion of the sealing member arranged on the front end edge and the rear end edge of the movable panel, shape and size of the sealing member at these two positions can be well kept.

In the above technical solution, preferably, the rigidity of the front end edge and the rear end edge of the movable panel is smaller than that of the vehicle top plate opposite to the front end edge and the rear end edge with the sealing member therebetween in the fully closed state of the sunroof apparatus, and the curvature, in the vehicle upper-lower direction, of the front end edge and the rear end edge of the movable panel before being installed to the vehicle top plate is greater than the curvature, in the vehicle upper-lower direction, of the vehicle top plate opposite to the front end edge and the rear end edge with the sealing member therebetween in the fully closed state of the sunroof apparatus.

In this way, before being installed to the vehicle top plate, the movable panel is formed in a convex shape relative to the vehicle top plate, so that the curvature of the movable panel after being installed to the vehicle top plate can be approximately the same as the curvature of the vehicle top plate. Therefore, the position of the surface of the movable panel with respect to the vehicle top plate does not need to be adjusted in the vehicle manufacturing factory, and the manufacturing procedures can be reduced.

In the above technical solution, preferably, the main body portion of the sealing member has a second hollow portion.

Therefore, the press-contact effect between the movable panel and the vehicle top plate can be reinforced, and the sealing performance is improved with a simple structure.

### BRIEF DESCRIPTION OF THE DRAWINGS

FIG. 1 is a schematic perspective view showing a sunroof apparatus arranged on a roof.

FIG. 2 is a rear side sectional view showing the sunroof apparatus of the present embodiment.

FIG. 3 is a left side sectional view showing the sunroof apparatus of the present embodiment.

FIG. 4 is a sectional view showing the front and the rear of the sunroof apparatus of the present embodiment.

FIG. 5 is a view of the prior art.

### REFERENCE SIGNS

1 sunroof apparatus
10 guide rail member
11 functional member accommodating portion
15 drain portion
2 roof opening
20 roof
22 bent portion
23 vehicle top plate
3 movable panel
31 front end edge
32 rear end edge
33 left end edge
34 right end edge
4 functional member
5 functional member support portion
7 sealing member
71 main body portion
72 press-contacted portion
73 first hollow portion
74 second hollow portion
75 filling member
8 panel reinforcement portion

### DETAILED DESCRIPTION OF THE EMBODIMENTS

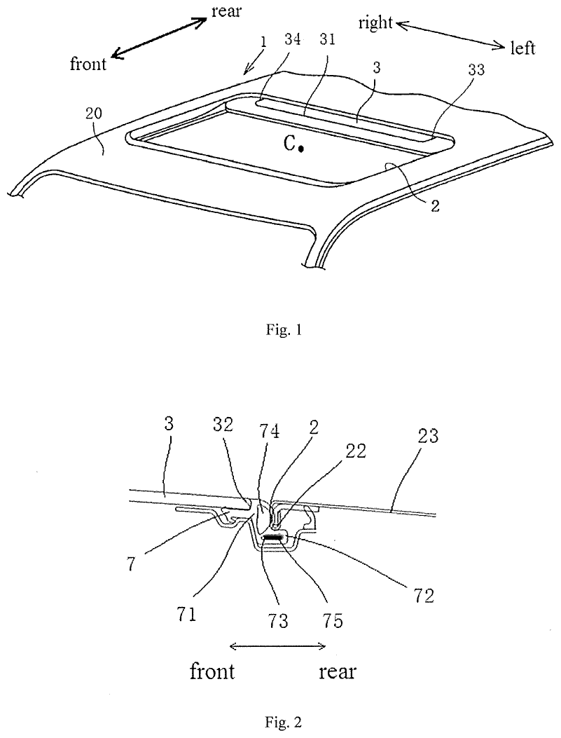

Hereinafter, the sunroof apparatus of the present embodiment will be specifically described with reference to FIGS. 1 to 4.

In FIG. 1, the “front” direction indicates a direction toward the front of a vehicle, the “rear” direction indicates a direction toward the rear of the vehicle, the “left” direction indicates a leftward direction when orienting toward the front of the vehicle, the “right” direction indicates a rightward direction when orienting toward the front of the vehicle, the “front-rear direction” corresponds to a “vehicle front-rear direction”, and the “left-right direction” corresponds to a “vehicle widthwise direction”. The “front-rear direction” in FIGS. 2 and 4 also corresponds to the “vehicle front-rear direction”.

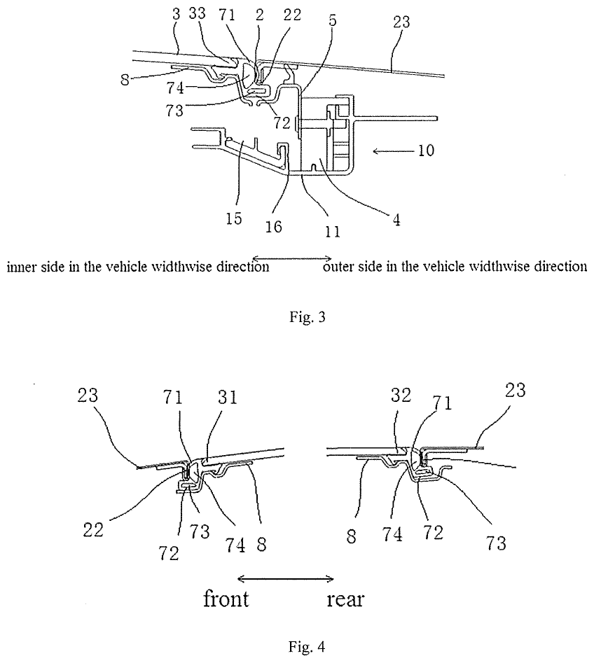

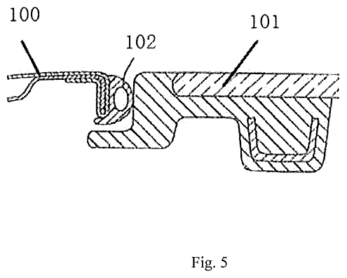

FIG. 3 shows a sectional view at a guide rail member on the left side of the vehicle, wherein the exterior-interior direction of a paper surface is the vehicle front-rear direction, the left-right direction of the paper surface is the vehicle widthwise direction, and the upper-lower direction of the paper surface is the vehicle upper-lower direction.

As shown in FIGS. 1 to 4, the sunroof apparatus 1 of the present embodiment includes a pair of guide rail members 10, 10; a movable panel 3; a functional member 4; a sealing member 7(weather strip); and a panel reinforcement portion 8.

The pair of guide rail members 10, 10 is arranged along the vehicle front-rear direction, on two opposite side edges in the vehicle widthwise direction of a roof opening 2 formed in a roof 20.

The movable panel 3 is configured to move along the vehicle front-rear direction to open and close the roof opening 2. The sunroof apparatus 1 of the present embodiment is a so-called internal sliding sunroof apparatus in which the movable panel 3 is located below the roof 20 when the roof opening 2 is completely opened through the movement of the movable panel 3.

The functional member 4 is configured to move along the pair of guide rail members 10, 10 and support the movable panel 3 to open and close the roof opening 2. The functional member 4 in the present embodiment is a pair of shoes sliding along the pair of guide rail members 10, 10, and the movable panel 3 can be driven to move in the vehicle front-rear direction by the pair of shoes. The functional member 4 can also include a pair of brackets (not shown) for supporting the movable panel 3. The movable panel 3 can be moved obliquely in the vehicle upper-lower direction by the brackets, that is, the movable panel 3 can be tilted upward or tilted downward through the rotation of the brackets around a fixed shaft.

As shown in FIGS. 2 to 4, the sealing member 7 is arranged on a front end edge 31 and a rear end edge 32 of the movable panel 3 along the vehicle widthwise direction and is arranged on a left end edge 33 and a right end edge 34 of the movable panel 3 along the vehicle front-rear direction. That is, the sealing member 7 is arranged to surround four edges of the movable panel 3. A bent portion 22 formed by bending a vehicle top plate 23 downward is arranged on the edge of the roof opening 2. The bent portion 22 can be formed on the whole edge of the roof opening 2. In this way, in the fully closed state of the sunroof apparatus 1, the movable panel 3 abuts against the bent portion 22 through the sealing member 7 arranged on the peripheral edges.

A sealing member 7 is provided with a main body portion 71 and a press-contacted portion 72. The press-contacted portion 72 is connected with the main body portion 71 and has a first hollow portion 73, and the main body portion 71 has a second hollow portion 74. In the fully closed state of the sunroof apparatus 1, the press-contacted portion 72 is pressed and contacted a lower end of the bent portion 22 in the vehicle upper-lower direction.

More specifically, both the main body portion 71 and the press-contacted portion 72 are formed into hollow bodies made of an elastic material, and the press-contacted portion 72 extend from the lower end of the main body portion 71 toward the lower end of the bent portion 22. By press-contact of the upper end of the press-contacted portion 72 with the lower end of the bent portion 22 in the vehicle upper-lower direction, an outside end of the main body portion 71 abuts against an inside end of the bent portion 22 in a direction from the center C (referring to FIG. 1) of the roof opening 2 toward the location of the press-contact, therefore the movable panel 3 with smaller rigidity and the vehicle top plate 23 with greater rigidity are reliably pressed and contacted with each other through the sealing member 7.

As shown in FIG. 2, filling members 75 are arranged in the first hollow portion 73 of the sealing member 7 arranged on the front end edge 31 and the rear end edge 32 of the movable panel 3, and the filling members 75 are located at centers in the vehicle widthwise direction in the first hollow portion 73. Therefore, the shape and the size of the sealing member 7 can be well kept on the front and rear end edges of the movable panel 3, without any corresponding functional member.

The rigidity of the front end edge 31 and the rear end edge 32 of the movable panel 3 is smaller than that of the vehicle top plate 23 opposite to the front end edge 31 and the rear end edge 32 with the sealing member 7 therebetween in the fully closed state of the sunroof apparatus 1. The curvature in the vehicle upper-lower direction, of the front end edge 31 and the rear end edge 32 of the movable panel 3 before being installed to the vehicle top plate 23 is greater than the curvature in the vehicle upper-lower direction, of the vehicle top plate 23 opposite to the front end edge 31 and the rear end edge 32 with the sealing member 7 therebetween in the fully closed state of the sunroof apparatus 1.

Specifically, the movable panel 3 being a part before being installed to the vehicle top plate 23 is formed into a convex shape with respect to the vehicle top plate 23, and in this way, after the movable panel 3 with smaller rigidity is installed to the vehicle top plate 23 with greater rigidity, the curvature of the movable panel 3 can be substantially the same as the curvature of the vehicle top plate 23 in the sunroof apparatus 1 as a finished product, so that in the vehicle manufacturing factory, the position of the surface of the movable panel 3 with respect to the vehicle top plate 23 does not need to be adjusted. That is, by making the curvature of the movable panel 3 with smaller rigidity serving as an installation fitting be greater than the curvature of the vehicle top plate 23 with greater rigidity at the corresponding installation position, during installation of the movable panel 3 to the vehicle top plate 23, the curvatures of them gradually become closer to each other, therefore an approximately smooth roof structure can be obtained without an additional procedure of adjusting a height of a surface.

As shown in FIGS. 3 and 4, the panel reinforcement portion 8 is arranged between the functional member 4 and the movable panel 3 and below the sealing member 7, supports the movable panel 3 and is a framework member capable of keeping the rigidity of the movable panel 3. Specifically, a structure is formed in which the sealing member 7 is gripped by the panel reinforcement portion 8 and the movable panel 3. One end of the panel reinforcement portion 8 is fixed to the movable panel 3 by bonding or injection molding, and the other end of the panel reinforcement portion 8 is connected with a functional member support portion 5 supported on the functional member 4. By above connected structure, the movable panel 3 can be stably supported when the functional member 4 moves along the guide rail member 10.

As shown in FIG. 3, each guide rail member 10 is provided with a functional member accommodating portion 11 and a drain portion 15. The drain portion 15 is arranged on the vehicle inner side of the functional member accommodating portion 11 with a partition wall 16 therebetween and is formed into a groove shape. In the present embodiment, the press-contacted portion 72 is located right above the drain portion 15 in the upper-lower direction with the panel reinforcement portion 8 therebetween. Therefore, even if a small amount of water or the like inflows through the gap between the bent portion 22 and the sealing member 7, the water can flow into the drain portion through a hole, a notch or the like formed in the panel reinforcement portion 8 and be discharged. Moreover, the water can be reliably prevented from invading the functional member accommodating portion 11 of the functional member 4 by using the partition wall 16.

The preferred embodiment of the invention have been described above, but the invention is not limited thereto, and various variations can be made without departing from the scope of the spirit of the invention.

For example, in the above embodiment, the structure of the sealing member has been described, but this is only an example. The shape of the sealing member of the invention is not limited to the embodiment and can be any shape as long as it can be pressed and contacted with the bent portion in the upper-lower direction. For example, the press-contacted portion of the sealing member may be not provided with the hollow portion, but is of a solid structure made of an elastic material, etc.

In the above embodiment, the structure in which the movable panel slides toward the rear of the vehicle to open the roof opening has been described. However, the invention is not limited thereto, and a structure in which the movable panel slides toward the front of the vehicle to open the roof opening may be used.

In the above embodiment, the structure of the sunroof apparatus only having the movable panel has been described. However, the invention is not limited thereto, and a structure in which a transparent fixed panel is arranged at the roof, and the moving panel is located below the fixed panel when the sunroof apparatus is in the fully open state may be used.

The present embodiment has been described above with reference to a specific example. However, the invention is not limited to the specific example. A design obtained by those skilled in the art by applying a suitable design change to the specific example is also included within the scope of the invention as long as it has the features of the invention.

1: A sunroof apparatus, comprising:
a roof opening, a bent portion formed by bending a vehicle top plate downward is arranged on an edge of the roof opening;
a movable panel which is configured to move along a vehicle front-rear direction to open and close the roof opening and is located below a roof when the sunroof apparatus is in a fully open state;
a sealing member which is arranged on a front end edge and a rear end edge of the movable panel along a vehicle widthwise direction and on a left end edge and a right end edge of the movable panel along the vehicle front-rear direction, the sealing member being provided with a main body portion and a press-contacted portion connected with the main body portion, the press-contacted portion being pressed and contacted with a lower end of the bent portion in a vehicle upper-lower direction in a fully closed state of the sunroof apparatus; and
a panel reinforcement portion which supports the movable panel and is arranged below the sealing member.

2: The sunroof apparatus according to claim 1, wherein
the press-contacted portion of the sealing member have a first hollow portion.

3: The sunroof apparatus according to claim 2, wherein
filling members are arranged in the first hollow portion of the sealing member which is arranged on the front end edge and the rear end edge of the movable panel, and the filling members are located at centers in the vehicle widthwise direction in the first hollow portion.

4: The sunroof apparatus according to claim 1, wherein
the rigidity of the front end edge and the rear end edge of the movable panel is smaller than that of the vehicle top plate opposite to the front end edge and the rear end edge with the sealing member therebetween in the fully closed state of the sunroof apparatus, and
the curvature, in the vehicle upper-lower direction, of the front end edge and the rear end edge of the movable panel before being installed to the vehicle top plate is greater than the curvature, in the vehicle upper-lower direction, of the vehicle top plate opposite to the front end edge and the rear end edge with the sealing member therebetween in the fully closed state of the sunroof apparatus.

5: The sunroof apparatus according to claim 1, wherein
the main body portion of the sealing member has a second hollow portion.

6: The sunroof apparatus according to claim 4, wherein
the main body portion of the sealing member has a second hollow portion.
